(19) United States
(12) Patent Application Publication
(10) Pub. No.: US 2024/0067548 A1
(43) Pub. Date: Feb. 29, 2024

(54) MODULAR SYSTEM FOR TREATING EFFLUENT FROM CLEANING HULLS OF FLOATING UNITS

(71) Applicants: PETRÓLEO BRASILEIRO S.A. – PETROBRAS, Rio de Janeiro (BR); SERVIÇO NACIONAL DE APRENDIZAGEM INDUSTRIAL - DEPARTAMENTO REGIONAL DA BAHIA-SENAI/DR/BA, Salvador (BR)

(72) Inventors: Marcelo Luiz LIGEIRO BARBOSA, Rio de Janeiro (BR); Edisiene DE SOUZA CORREIA, Salvador (BR); Lucas SARMENTO NEVES DA ROCHA, Salvador (BR); Edna DOS SANTOS ALMEIDA, Salvador (BR); Mateus DOS SANTOS DE MENEZES, Salvador (BR); Carlos Eduardo DA SILVA JORGE, Salvador (BR); Frederico GARCIA DE OLIVEIRA, Salvador (BR); Luis Carlos MORENO LEDEZMA, Salvador (BR); Alexandro QUIRINO DA SILVA, Salvador (BR); Joaquim RANYERE SANTANA DE OLIVEIRA, Salvador (BR)

(21) Appl. No.: 18/259,889

(22) PCT Filed: Dec. 20, 2021
(86) PCT No.: PCT/BR2021/050566

§ 371 Date: Jun. 29, 2023

(30) Foreign Application Priority Data
Dec. 30, 2020 (BR) 10 2020 027017 6

(51) Int. Cl. C02F 9/00; C02F 1/00

(52) U.S. Cl. CPC C02F 9/00; C02F 1/008; C02F 1/38

(57) ABSTRACT

The present invention is a system for treating effluent from robotic equipment used to remove marine biofouling, primarily targeting organisms such as orange cup coral, which collect on hulls of floating units for transporting oil and derivatives thereof, or on production and exploration platforms. The system involves separating the flow into two elemental phases: solid and liquid. In the solid-phase flow, treatment is carried out in steps essentially comprising particle-size reduction, direct oxidation, oxidation residence, separation, drying, temporary hermetic storage, packaging, and automatic transportation for final storage. The liquid phase includes a step of centrifuging, adsorption, inerting, and discharge of treated effluent into the sea in accordance with environmental law. The entire system is automated to minimize manual actions and interventions, and is programmed to run without interruption as a function of the flowrate of raw effluent.

### FIELD OF THE INVENTION

The present invention is related to the treatment of bio-scales removed from the hulls of floating units. The Modular System for Effluent Treatment (MSET) aims at processing the biowaste generated during marine bio-scaling removal activities, carried out by a robot, containing the solid part of this residue on the surface and returning the liquid effluent to the marine environment in environmentally acceptable conditions. More specifically, the present invention aims at the treatment of marine bio-scaling predominantly composed of calcareous organisms with a rigid skeleton such as stony or scleractinian corals, with the possibility of the presence of fibrous organisms, with a thickness ranging from 2.5 to 30 cm thick, designated herein macro-scaling.

### DESCRIPTION OF THE STATE OF THE ART

Marine bio-scaling occurs on FPSO hulls, semi-submersible platforms, support/service vessels and similar ship hulls, and may be up to 30 centimeters thick. This thick layer increases resistance to slipping in water and, consequently, fuel consumption, as well as causing corrosion on the surface, in addition to increasing the weight of the vessel.

Due to the development of bio-scaling on vessels, platforms and floating structures in general, these bulkheads are one of the main vectors of dispersion and introduction of exotic species in the marine environment. The aim is to contain and control the population of these proliferative species due to the potential impacts on native species, which may reduce or affect the biodiversity of the Brazilian coast.

One of the main invaders of Brazilian biodiversity is the Sun Coral, from the Pacific Ocean, known since the 80s, for having invaded the rocky shores of the coast. Some studies have proven that sun coral is an efficient invader, with rapid growth. The sun coral modifies the invaded environment, creating a favorable environment for its permanence, and for that it produces harmful chemical substances which exclude some actors of the native fauna and flora. The sun coral was also observed killing native coral species, some even endemic to Brazil, competing with species of economic value, such as the mussel, affecting primary and coastal productivity (fisheries and sea resources), thus harming a source of food.

National laws require the identification, monitoring and elimination of non-native organisms that have settled in natural areas of biological importance. The aim is to eliminate these proliferative species due to the impacts on native species, which may reduce or affect the biodiversity of the Brazilian coast. This motivation created the need of designing a robot and an effluent treatment system.

The development of technologies where a robotic system is coupled with an effluent treatment module removing bio-scaling, which guarantees the proper disposal of solid waste generated and the return of liquid effluent to the sea (free of living organisms), preventing proliferation of exotic species, is highly desirable, especially for macro-scales.

Macro-scales containing biogenic calcium carbonate (BCC) are important components in biological systems such as shells of marine organisms, pearls and eggshells. Biomineralization, that is, the formation of biogenic crystals, consists of a biological process of nucleation and growth of a crystalline deposit, under highly controlled conditions, in an organic matrix. The organic matrix is an organized surface that mediates the mineralization process and is formed mainly by glycoproteins, polypeptides and polysaccharides. The proteins present in the soluble fraction direct the growth of a particular isomorphism, the most common being aragonite and calcite. Therefore, the formed material consists of composites in alternating layers of calcite, aragonite and organic matter, and this arrangement is responsible for its different mechanical characteristics.

The biowaste generated by the removal of macro-scaling from the hulls of floating units contains a significant amount of biogenic calcium carbonate impregnated with soft organic tissues of the marine organism that will constitute a solid phase in the effluent to be treated. The typical operations of urban and industrial effluent treatment units that currently exist do not consider the need of treating and disposing of a solid phase rich in dented biogenic calcium carbonate with a high content of impregnated organic matter in the environment. A typical effluent treatment unit comprises primary treatment, secondary treatment and sludge treatment steps. The primary treatment operations or functions aim at separating coarse and eventual solids that are carried by the effluent such as leaves, branches, pebbles, and other solid materials from urban disposal.

The dented macro-scaling generated by crushing in the robotic unit therefore carries with it a solid phase of a different nature, it is rich in biogenic calcium carbonate, a large amount of organic content that needs to be removed for correct storage and disposal in the environment of the generated solid waste. There is a lack of suitable processes in the state of the art for the treatment of solid waste originating from calcareous marine organisms, especially coupled to a robotic removal unit.

The invention application WO2019028562A1 discloses a cleaning machine that has a coupled ultraviolet effluent treatment, and all the removed organic matter can be treated on the surface by other systems usually installed on an auxiliary vessel. Although the device was designed to mitigate the dispersion of invasive marine organisms in the environment by removing and sending the effluent to be treated at the surface, the brush removal system is not suitable for removing calcareous organisms larger than 10 cm as well as effluent treatment system for organisms is not disclosed.

The invention U.S. Pat. No. 7,905,192B1 presents an integrated system for cleaning underwater surfaces and for treating effluents with the objective of removing marine bio-scaling, mitigating the problem of dispersion in the environment of paint particles, containing copper and zinc, which are detached from the surface during the operation. The on-land treatment unit has the function of treating the residue received from a cleaning vehicle and converting it into dehydrated solid and treated effluent, in which the residue can pass through a crushing module coupled to the vehicle. According to the invention, this treatment unit has a gravity decanting unit, a chemical treatment unit and a unit for thickening the solid residue. The chemical treatment unit comprises a neutralization chamber with NaOH injection, a coagulation chamber with FeCl₂ injection, a polymer injection vessel, a maturation chamber and a clarifier. The unit further comprises a solids recirculation pump at the lower part of the clarifier which sends to a hydrocyclone.

Both the cleaning vehicle and the effluent treatment unit described in the patent document U.S. Pat. No. 7,905,192B1, have restrictions for application in floating hull units containing macro-scales, especially those containing Sun Coral. The described vehicle does not have the advantage of removing dense bio-scale with a high content of calcareous organisms, as it uses brushes that are not suitable for removing calcareous organisms larger than 10 cm, and the crushing system is not detailed in order to demonstrate its suitability for these organisms containing biogenic calcium carbonate of size greater than 10 cm as the present invention.

Even if the cleaning vehicle had the ability to crush the macro-scaling to a particle size equal to or less than ⅜ in (1 mm) as claimed, the described effluent treatment system would not have one hundred percent removal capacity of heavy metals, as it does not have an adsorption unit, nor does it make use of calcium carbonate as will be described in the present invention.

The invention proposed herein can be fully applied to meet the environmental restrictions on the disposal of biowaste generated in the macro-scale-type marine bio-scaling removal operation, preferably containing sun coral, from the hulls of floating units (FPSO, SS, NS and service/support vessels and similar hulls).

In order to solve the related problems, the present invention was developed to meet not only the environmental requirements related to bio-scaling containing Sun Coral, but it was also developed with a focus on increasing productivity through more efficient removal and treatment in execution time, because the faster the removal, the sooner a unit (FPSO, SS, etc.) is released for its core activity, avoiding production losses due to downtime waiting for the removal of marine bio-scaling from the hull.

Accordingly, it should be emphasized that the MSET to receive effluent with specific dimensions and dented, must be coupled to a unit for removal, capture and crushing of bio-scaling, and prevent the removal product from being released into the marine environment, being sent by an effluent transport system to the MSET.

### SUMMARY OF THE INVENTION

The proposed invention is a Modular System for Effluent Treatment (MSET) that is subdivided into 22 different functions, which receives the raw effluent and separates the biowaste into basically two main streams, namely: the solid effluent stream and liquid effluent stream being also fed by two auxiliary streams, one containing water and the other containing oxidizing additives.

The treatment system receives all the raw effluent in a crushed and dented form, which must be 100% operational during the action of the robotic equipment, without any failure of any of the functional equipment.

The support vessel, which has the treatment unit installed, contains space for packaging and storage of the final solids, whose operations can occur 300 km from the coast. The liquid effluent is free of microscopic organisms and metallic elements, which can return to the sea without any obstacles. The solid residue has its organic matter content reduced and undergoes a drying process reaching a humidity of less than 10%. This residue, because it contains a high concentration of calcium carbonate, can be used in the transformation industry.

### BRIEF DESCRIPTION OF THE FIGURES

The present invention will be described in more detail below, with reference to the attached figures that, in a schematic and non-limiting way of the inventive scope, represent examples of its embodiment. In the drawings, there are:

FIG. 1 representing a pictogram with the equipment and streams of the Modular System for Effluent Treatment (MSET).

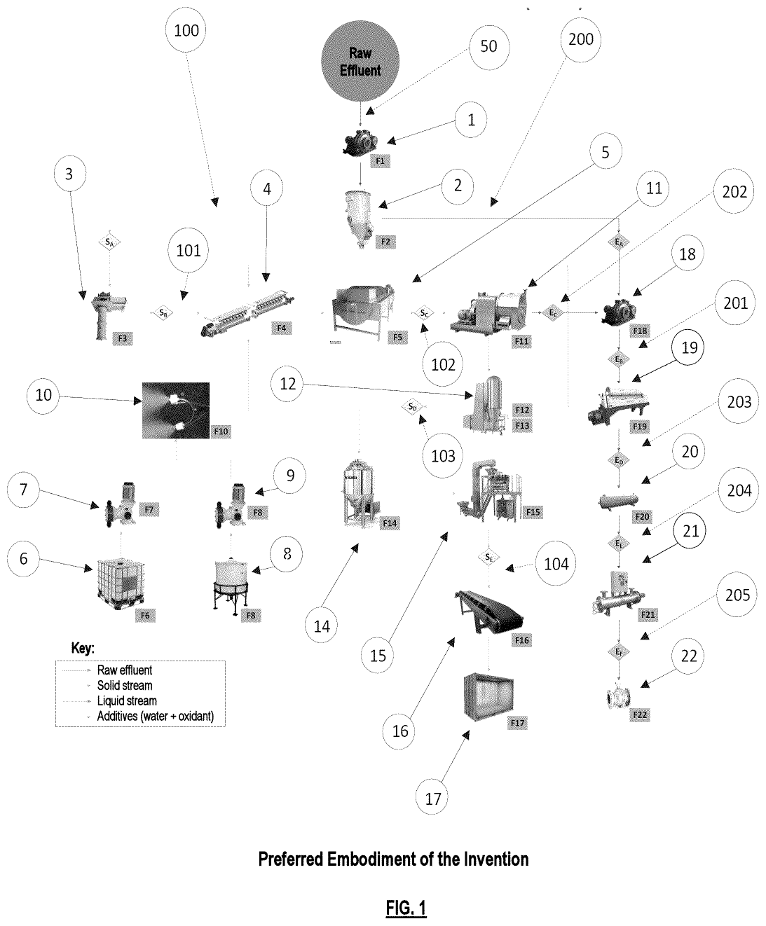

FIG. 2 representing the three-dimensional design of the treatment unit.

### DETAILED DESCRIPTION OF THE INVENTION

The present invention was conceived aiming at the separation of the raw effluent generated by the removal unit, capture and crushing of macro-scaling containing a liquid phase and a solid phase that arrives at the modular unit. For the separation of these phases to occur, initially, the raw effluent stream (50) is transported by a pump (1) preferably with rotor and centrifugal casing, effluent which contains marine bio-scaling (pre-crushed and dented) mixed with the liquid phase, and fed into a solid-liquid separator (100) made up of a preferably self-cleaning rotary filter (2), which separates the different phases of the raw effluent to divide the solid stream (100) and liquid stream (200). The basic characteristic of the solid stream (200) is high humidity, agglomerated mass, biogenic calcareous materials with granulometry above 0.05 mm, reaching up to 2 cm, a high amount of living organisms and organic material and the possible presence of metallic oxides. The liquid stream still contains smaller solid particles, but which can reach up to 0.15 cm, low presence of metals and dissolved organic matter and a low amount of living organisms and colloidal particles.

The solid stream (100) goes to a comminution equipment whose function is to reduce the size of the particles, and thus increase the surface area of the solid waste particles, in order to increase the efficiency of the next process and equipment, which deals with of an oxidation process, this being the flexible tubular helical conveyor (4). The comminution equipment can be a vertical mill (3) and this can easily be replaced by a vertical cylinder mill. The stream S B (101) that exits the vertical mill (3) and goes to the flexible helical conveyor (4) normally consists of a fragmented mass with a granulometry smaller than 0.05 mm, but still has a high amount of living organisms. This mass undergoes an oxidation process in the helical tank (5), where additives are injected through electrostatic spray nozzles (10), which adds diluted oxidant to the solid phase. The helical tank (5) promotes a high residence time for the oxidation process, allowing it to be mixed with wet solid waste, increasing its power of action on soft and organic material. The stream is then free of living organisms but still contains metal oxide particles.

The additives that are added to the stream S_{B} (101) and inserted into the equipment (4) are usually stored in IBC tanks or reservoirs (6) and are mixed with clean water (8), which is also stored in tanks of plastics (8) or equivalent reservoirs. Mixing the additive with clean (fresh) water is done using dosing pumps (7) and (9), which can be diaphragm or piston type.

The solid stream (102) reaches a Pusher centrifuge (11), which separates the oxidized solid material from the liquid (usually water and other liquid waste) and breaks the stream into two parts (phases), one that is destined for the fluidized bed dryer (12) and another that deals with the liquid effluent E_{C} (202), whose stream is destined for a pump (18). The liquid effluent (202) is still rich in oxidizing additives and with the presence of metallic parts of low concentrations that were diluted. The solid waste that was taken to the fluidized bed dryer (12) has a reduced volume and is less susceptible to the decomposition of organic matter, in addition to the fact that drying prevents the action of humidity in generating bad odors and proliferation of harmful vectors to human health.

After the drying process, the solid stream S_{D} (103), which has low humidity and with some presence of organic matter, is sent to a hermetic silo (14), and then to an automatic packer (15). The function of the hermetic silo (14) is to temporarily store the final solids as if it were a temporary stock, giving a certain capacity to the system interconnected with the teleoperated robot that is acting in the field. After going through this step, the residues are enveloped to avoid re-wetting of the internal content due to exposure to the elements arising from the marine operating environment. The solids S E (104), at this stage, have low moisture content, so that it is less than 10%, and are vacuum packed. It is likely that this residue contains some particles of metallic oxides.

In order to release the solids at the end of the line, a conveyor belt (16) is placed, which sends the packaged waste to a container (17), which is used to store the final solids, and thus ends this stream of treatment. All of these solutions for the final packaging of dry solid waste and respective storage are designed to ensure insulation against external humidity from the marine environment, thus preventing re-humidification and the proliferation of odors. Additionally, this treated solid waste can be used in the manufacturing industry due to its high content of calcium carbonate.

From the solids and liquids separator (2), a liquid effluent stream E_{A} (200) is also generated, still with a high concentration of suspended solids, and particles between 0.05 and 1.5 mm in diameter, although with a low concentration of dissolved organic material. Even so, there is in this liquid effluent stream E_{A} (200) a number, albeit low, of living organisms and colloidal particles. Analogously to solid stream, this stream is treated in a sequence of unit operations in appropriate equipment.

A pump (18) sucks the effluent streams E_{A} (200) and E_{C} (202), the latter rich in oxidants and metallic elements. With the mixture of these two streams, a stream E_{B} (201) is obtained with a high concentration of suspended organic and inorganic solids (0.05 to 1.5 mm), similar to an effluent originating from micro-scaling, metals and dissolved organic matter, and living organisms with colloidal particles.

With this, the effluent rich in contaminants E_{B} (201) is taken to the Decanter Centrifuge (19), in order to separate the suspended particles from the liquid phase, mainly to remove as much of the sediment content as possible still contained in the liquid effluent, including fine particles possibly in suspension. The separated particles are sent to the helical conveyor (4) inserted in the solid stream S_{B} (101). The product of this separation, the effluent E_{D} (203), produced by the Decanter Centrifuge (19), is a liquid stream with clarified effluent and free of metallic oxide particles. Even so, there is still some probable presence of metals and dissolved organic matter, microscopic organisms and some traces of solids (both organic and inorganic).

The effluent E_{D} (203) is sent to a pressure adsorption vessel (20) which aims at eliminating metals that are still dissolved in the liquid. Thus, there is an effluent E_{E} (204) free of metallic oxides and dissolved metals. It still remains to eliminate microscopic organisms and organic material. The effluent E_{E} (204) is then sent to an ultraviolet inertization step (21), which eliminates traces of larvae and oocytes, mainly sun coral, in order to ensure the organism does not disperse. Finally, there is a treated effluent E_{F} (205) being sent to a release valve (22), which returns to the maritime environment totally inert and free of microscopic organisms and metallic elements.

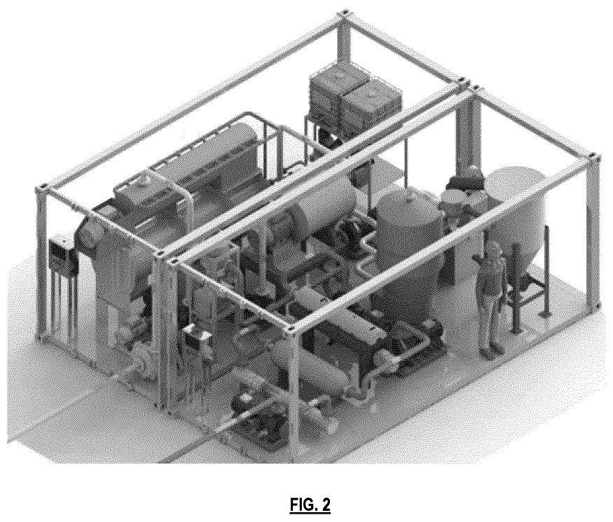

All solutions employed were designed in a modular way and in a grouped way, as shown in FIG. 2. Individual equipment are usually found on the market; however, the present invention focuses on serial and intensified organization to achieve objectives and concentrations of the quality of effluent regulated by environmental agencies. The step carried out by the pressure adsorption equipment (20) is carried out by an extremely efficient process, mainly considering low concentrations of dissolved paints and metals. The initial solid-liquid separator element, which was chosen as a single piece of equipment for reasons of space (occupied area) being a self-cleaning rotary filter (2), and which could have been dismembered into two other pieces of equipment such as a self-cleaning rotary sieve (for coarse 2 cm solids) and a centrifugal sieve (for medium solids), usually produces high solids concentrations and a wide range of particle sizes. Whatever the solutions or variants may be, one must observe not only the area to be occupied, but the influence of the intrinsic instability of the vessel thereon. In this way, it is advisable that the principle of operation of the mentioned solution is not strongly based on gravitational force, which could make its use unfeasible even in calm sea conditions with reduced wave heights.

The vertical mill (7) could be replaced by a vertical cylinder mill. The flexible tubular helical conveyor (4) and the helical tank (5) could be replaced by a sand washer. The IBC reservoir (8) for storing water can be replaced by a plastic tank or any other equivalent equipment. The fluidized bed dryer (12) can work together with a pneumatic conveyor (13), which allows transporting dry oxidized solids to the next step of the process and, at the same time, promoting disaggregation of the resulting particles to optimize the drying process. The pressure adsorption vessel (20) can be replaced by an activated carbon adsorption vessel, maintaining the same objective of removing dissolved metals. And, finally, to inert the effluent, ultraviolet inerting can be replaced by an ozonation system or a system composed of ultraviolet and peroxide (usually hydrogen peroxide (H₂O₂)).

Some specific operating scenarios/conditions allow adaptations, by-pass and/or suppressions of functions. For these cases, it is possible to use a simplified projection of the MSET. As an example, one can cite the scenario of MSET operating on land (e.g., shipyard or dock), where there is the possibility of suppressing the final steps of transporting dry solids and storage in containers, directing such waste directly to transport trucks responsible for its final destination. In this same scenario on land, a second example of the possibility of even greater suppression would be not having the oxidation steps of the organic content present (e.g., addition, mixing, transport, increasing the oxidation time), considering the possibility of proximity to the cleaning operation with an advanced waste processing center, and making sure that the solid waste generated does not have time to putrefy while still at the operation site. Another example is to consider the non-existence (through experimental tests) of paint residues and dissolved and particulate metals in the liquid effluent, and thus suppress the adsorption and metal removal step of the process.

However, although technically possible, such adaptations, by-pass and/or suppressions of functions are not recommended, since the natural variability of bio-scaling (quantity, content, hardness, abrasiveness, among other variables) found in different scenarios/conditions brings a great deal of uncertainty as to the real needs of the treatment plant.

Based on the technical requirements of the solution, it was defined that the entire operation and control of the process provided for the MSET must be automated, in order to reduce operator intervention in the process and in decision making. In this case, the implementation of a level 3 architecture in the automation pyramid according to the standard ANSI/ISA95 was proposed. It is worth to emphasize that the standard ANSI/ISA95 (Integration of the corporate system with control) is not an automation system, but a method, a way of working, thinking and communicating. The MSET automation concept provides for a large-sized PLC control system due to its flexibility to meet the most demanding applications and environments, in addition to offering modular architectures and a range of I/O and network options. Another need from the point of view of MSET automation is the use of a SCADA (Supervisory Control and Data Acquisition) supervisory system with robust and flexible features.

1. A modular system for treatment of effluents from the cleaning of floating unit hulls, which receives and treats the crushed and dented effluent from the coupling with automated robotic systems, characterized in that:
the entry path of the raw effluent (50) is through a pump (1) that sends the same to a solid-liquid separator, wherein the stream is divided into two, consisting basically of solids S_{A} (100) and a stream of liquid E_{A} (200) for treatment;
the treatment process is basically divided into twenty-two functional steps separated into two streams, consisting basically of solid S_{A} (100) and a liquid stream E_{A} (200).
the predominantly solid phase stream (100) is treated gradually, in steps that are subdivided into S_{A} (100), S_{B} (101), S_{C} (102), S_{D} (103) and S_{E} (104);
the predominantly liquid phase stream E_{A} (200) is mixed with the stream E_{C} (202), forming the stream E_{B} (201) which is treated gradually, in steps that are subdivided into E_{D} (203), E_{E} (204) and E_{F} (205).

2. The modular treatment system according to claim 1, characterized in that the equipment for the treatment of solid stream S_{A} (100) consist of: vertical mill (3), flexible tubular helical conveyor (4), helical tank (5), IBC reservoir (6), dosing pumps (7) and (9) and IBC water reservoir (8) and spray nozzles (10), Pusher centrifuge (11), fluidized bed dryer (12), hermetic silo (14), automatic packer (15), conveyor belt (16) and a container (17).

3. The modular treatment system according to claim 1, characterized in that the equipment for treating the liquid stream E_{A} (200) consist of: a centrifugal pump (18), a decanter centrifuge (19), a pressure adsorption vessel (20), an ultraviolet inertizer (21) and a release valve (22).

4. The modular treatment system according to claim 1, characterized in that the solid-liquid separator that receives the effluent (50) is of the self-cleaning rotary filter type (2).

5. The modular treatment system according to claim 1, characterized in that the effluent S_{B} (101) comes from a comminution step, wherein it is carried out preferably by a vertical mill (3).

6. The modular treatment system according to claim 1, characterized in that the effluent S_{C} (102) comes from an oxidation step, wherein it is carried out preferably by a flexible tubular helical conveyor (4) and a helical tank (5).

7. The modular treatment system according to claim 1, characterized in that the effluent S_{D} (103) comes from a solid-liquid separation and drying step, wherein each step is preferably performed by a Pusher centrifuge (11) and by a fluidized bed dryer (12), respectively.

8. The modular treatment system according to claim 7, characterized in that the solid-liquid separation is by means of pressure or centrifugation.

9. The modular treatment system according to claim 7, characterized in that the drying is carried out by direct contact with hot air.

10. The modular treatment system according to claim 1, characterized in that the effluent S_{E} (104) comes from a storage step and another from the packaging step, wherein the first is carried out by a hermetic silo (14), and the second is carried out by an automatic packer (15).

11. The modular treatment system according to claim 1, characterized in that the effluent S_{E} (104) is composed of biogenic calcium carbonate with moisture equal to or less than 10%.

12. A modular treatment system process according to claim 1, characterized in that the effluent E_{D} (203) comes from a solid-liquid separation step, wherein it is performed by a Decanter Centrifuge (19), and this centrifuge sends the particles separated for the helical conveyor (4).

13. The modular treatment system according to claim 12, characterized in that the solid-liquid separation step is by means of pressure or centrifugation.

14. The modular treatment system according to claim 1, characterized in that the effluent E_{E} (204) comes from an adsorption step, wherein it is carried out by a pressure adsorption vessel (20).

15. The modular treatment system according to claim 1, characterized in that the effluent E_{F} (205) comes from an inerting step, wherein it is carried out by an ultraviolet inerting equipment (21).

16. The modular treatment system according to claim 2, characterized in that the step which consists of the vertical mill (7) is carried out by a vertical cylinder mill.

17. The modular treatment system according to claim 2, characterized in that the steps consisting of the tubular helical conveyor (4) and helical tank (5) equipment can be performed only by a sand washer.

18. The modular treatment system according to claim 3 or 14, characterized in that the adsorption step, responsible for removing dissolved metals, is performed by equipment containing adsorption by activated carbon.

19. The modular treatment system according to claim 3 or 15, characterized in that the inerting step is carried out by an ozonation equipment or an ultra-violet equipment with peroxide.

20. The modular treatment system according to claim 1, characterized in that the treatment unit is automatically controlled by an automation architecture standard of level 3 of the standard ANSI/ISA95, and an instrumentation standard based on the standard ISA 5.1, wherein the control system is made by PLC logic and monitored through a supervisory system of the SCADA type.
